(19) United States
(12) Patent Application Publication
(10) Pub. No.: US 2024/0251975 A1
(43) Pub. Date: Aug. 1, 2024

(54) AUTOMATED CONDIMENT DISPENSER

(71) Applicant: CFA Properties, Inc., Atlanta, GA (US)

(72) Inventors: Andy Wu, Atlanta, GA (US); Gunner Petrea, Atlanta, GA (US); Nicolas J. Soave, Atlanta, GA (US); Devin Tyman, Atlanta, GA (US); Andrew Feltus, Atlanta, GA (US); Stephen Bogner, Atlanta, GA (US)

(21) Appl. No.: 18/423,887

(22) Filed: Jan. 26, 2024

Related U.S. Application Data
(60) Provisional application No. 63/481,715, filed on Jan. 26, 2023.

(51) Int. Cl. A47G 19/18; B25J 11/00; B25J 15/06

(52) U.S. Cl. CPC A47G 19/183; B25J 11/0045; B25J 15/0683

(57) ABSTRACT

Embodiments of the present disclosure relate to a system and method for automated condiment container dispensing. An example system includes a cabinet including a plurality of shelves, a dispenser chute centrally aligned in front of a plurality of staging surfaces, and a controller. A respective shelf may be aligned with a staging surface, and an edge of the staging surface may be adjacent to the dispenser chute. The shelf may include at least one conveyor configured to receive at least one row of condiment containers and, upon activation, advance a respective row of condiment containers onto the staging surface. The shelf may include at least one actuator configured to, upon activation, advance at least a subset of the respective row of condiment containers from the staging surface into the dispenser chute. The controller may control activation of the at least one conveyor and the at least one actuator.

### CROSS-REFERENCE TO RELATED APPLICATIONS

This application claims the benefit of and priority to U.S. Provisional Application No. 63/481,715, filed Jan. 26, 2023, entitled “CONDIMENT DISPENSER,” the disclosure of which is incorporated herein by reference in its entirety.

### TECHNICAL FIELD

This application generally relates to systems and processes for improving efficiency, accuracy, and throughput of obtaining condiments.

### BACKGROUND

In quick-service restaurants (QSR), customers often have a variety of condiments, sauces and the like to choose from when ordering their meals. When ordering meals, such as from an instore counter, from a drive-thru, or for delivery or mobile order pick-up, the condiments and sauces are often provided in small, sealed containers that are placed into a bag along with the main meal items. This has historically been a manual process whereby the restaurant team member places the desired type and number of containers into the bag in response to a request from the customer. However, incorrect or missing condiment containers is one of the most common complaints from customers, and manually placing the condiment containers into the bag is a time-consuming and challenging task for the team members. Restaurants have not yet solved the challenge of accurately and quickly supplying condiments in response to a customer order.

### BRIEF SUMMARY

Embodiments of the present disclosure relate to apparatuses, devices, systems, and methods for automated container dispensing. An example apparatus for automatically dispensing one or more condiment containers may include a cabinet comprising a plurality of shelve and a dispenser chute centrally aligned in front of a plurality of staging surfaces. The plurality of staging surfaces may be vertically arranged, and an edge of a respective staging surface may be adjacent to the dispenser chute. A respective shelf may be aligned with a respective staging surface. A respect shelf may include at least one conveyor configured to receive at least one row of condiment containers and, upon activation, advance a respective row of condiment containers onto the staging surface. The shelf may include at least one actuator configured to, upon activation, advance at least a subset of the respective row of condiment containers from the staging surface into the dispenser chute. The apparatus may further include at least one controller configured to control activation of the at least one conveyor and the at least one actuator.

In some embodiments, the at least one controller is further configured to activate at least one conveyor to dispense at least one row of condiment containers onto the respective staging surface. In some embodiments, the at least one controller is further configured to receive a request from at least one of an input device or a kitchen production apparatus (KPS), wherein the request defines at least one condiment type and at least one condiment quantity. In some embodiments, the at least one controller is configured to activate at least one actuator based on the request to enable dispensing of at least one condiment container of the at least one condiment type and at least one condiment quantity.

In some embodiments, the apparatus further comprises a robotic arm comprising a plurality of vacuum cups. A respective vacuum cup may be configured to i) in an activated state, attach to a condiment container via suction, and ii) in a deactivated state, release the condiment container via suspension of the suction. In some embodiments, the robotic arm is configured to align at least a subset of the plurality of vacuum cups over at least one row of condiment containers stored in a reservoir. In some embodiments, the robotic arm is further configured to, in response to a transition of the subset of the plurality of vacuum cups to the activated state, align the plurality of vacuum cups over the at least one conveyor to enable depositing of the at least one row of condiment containers via a transition of the subset of the plurality of vacuum cups to the deactivated state.

In some embodiments, the at least one controller is further configured to determine that a quantity of condiment containers on the at least one conveyor is less than a predetermined threshold. In such embodiments, in response to the determination, the at least one controller may activate the robotic arm to enable depositing of the at least one row of condiment containers on the at least one conveyor.

In some embodiments, a respective shelf is attached to a linear actuator. In some embodiments, the at least one controller is further configured to, in response to the determination that the quantity of condiment containers on the at least one conveyor is less than the predetermined threshold, cause the linear actuator to horizontally translate the shelf such that a top surface of the at least one conveyor is exposed to the robotic arm. In such embodiments, the at least one controller may following the depositing of the at least one row of condiment containers on the at least one conveyor, cause the linear actuator to reverse translate the shelf to realign the at least one conveyor with a respective staging surface.

In some embodiments, a respective vacuum cup is configured to engage a flat top surface of the condiment container. In some embodiments, the at least one conveyor is configured to engage a flat bottom surface of the condiment container. In some embodiments, the robotic arm further comprises at least one secondary vacuum cup configured to secure to a product divider disposed on top of the condiment container via suction when configured to an active state.

In some embodiments, the apparatus further comprises an input device configured to receive user input defining a request to dispense at least one quantity of at least one type of condiment from the cabinet. In such embodiments, the at least one controller may be further configured to receive the request from the input device and activate at least one of the conveyor and the actuator of at least one the plurality of shelves to enable dispensing of at least one condiment container based on the at least one quantity and the at least one condiment type. In some embodiments, the input device comprises a touchscreen display. In such embodiments, the at least one controller may be further configured to: receive at least one customer order, generate the at least one quantity and the at least one type of condiment based on the customer order; and, cause rendering of the at least one customer order on the touchscreen display, wherein the user input defining the request comprises a selection of the at least one customer order.

Another example apparatus for automatically dispensing condiment containers may include at least one staging surface adjacent to a dispenser chute, the dispenser chute defining a void for dispensing condiment containers under gravity. The apparatus may include at least one conveyor configured to receive a plurality of condiment containers and, upon activation, advance a subset of the plurality of condiment containers onto the at least one staging surface. The apparatus may further include at least one actuator configured to, upon activation, advance the respective condiment container from the at least one staging surface into the dispenser chute. The apparatus may also include at least one controller configured to obtain a request to dispense at least one condiment container and activate the at least one conveyor and the at least one actuator based at least in part on the request.

In some embodiments, the at least one conveyor comprises a plurality of conveyors. In such embodiments, a respective conveyor is configured to receive a plurality of condiment containers and, upon activation, advance a subset of the plurality of condiment containers onto a respective staging surface. In some embodiments, the at least one actuator comprises a plurality of actuators, wherein each of the plurality of actuators is aligned with a respective conveyor. In some embodiments, the at least one controller is configured to determine at least one condiment type and at least one quantity based at least in part on the request. In such embodiments, the at least one controller may be configured to activate at least one conveyor of the plurality of conveyors and/or at least one actuator of the plurality of actuators based at least in part on the at least one condiment type and the at least one quantity to dispense the at least one condiment container from the dispenser chute.

In some embodiments, the apparatus includes a display, wherein the at least one controller is further configured to render, on the display, a graphical user interface (GUI); and obtain the request to dispense the at least one condiment container via at least one input to the GUI. In some embodiments, the GUI comprises a plurality of selectable fields associated with a plurality of condiment types, respectively. In such embodiments, the at least one controller may be further configured to obtain the request to dispense the at least one condiment container in response to the GUI receiving at least one selection of one of the plurality of selectable fields. In some embodiments, each of a subset of the plurality of selectable fields is associated with a customer order, wherein a respective customer order comprises the at least one condiment type and the at least one quantity.

An example, method for automatically dispensing condiment containers may include laterally advancing a row of condiment containers from a flat surface onto at least one staging surface. The method may include receiving a request for at least one condiment container and, based on the request, longitudinally advancing at least a subset of at least one row of condiment containers to an end of the staging surface to cause the subset of the at least one row of condiment containers to fall into a dispenser chute. In some embodiments, the at least one staging surface comprises a first staging surface associated with a first condiment type and a second staging surface associated with a second condiment type. The request may define a quantity of the first condiment type and a second quantity of the second condiment type. In such embodiments, the method may further comprise longitudinally advancing a subset of a row of condiment containers of the first staging surface into the dispenser chute and longitudinally advancing a second subset of a second row of condiment containers of the second surface into the dispenser chute.

In some embodiments, the method further comprises horizontally translating the flat surface from a first position to a second position and applying suction to an additional row of condiment containers to enable repositioning. In such embodiments, the method may further include aligning the additional row of condiment containers over the flat surface, releasing the suction to deposit the additional row of condiment containers onto the flat surface, and reverse translating the flat surface from the second position to the first position.

In some embodiments, the request is received from a kitchen production apparatus (KPS). In some embodiments, the request comprises a customer order and the method further comprises determining a quantity of condiment containers in the subset of the row of condiment containers based on the customer order.

### BRIEF DESCRIPTION OF THE FIGURES

Having thus described the embodiments of the disclosure in general terms, reference now will be made to the accompanying drawings, which are not necessarily drawn to scale, and wherein:

FIG. 1 shows a front perspective view of an example condiment dispenser in accordance with some embodiments of the present disclosure;

FIG. 2 shows a front perspective view of an example cabinet of a condiment dispenser in accordance with some embodiments of the present disclosure;

FIG. 3 shows a front perspective view of an example cabinet of a condiment dispenser in accordance with some embodiments of the present disclosure;

FIG. 4 shows a rear perspective view of an example cabinet of a condiment dispenser in accordance with some embodiments of the present disclosure;

FIG. 5 shows a front view of an example cabinet of a condiment dispenser in accordance with some embodiments of the present disclosure;

FIG. 6 shows a right-side view of an example cabinet of a condiment dispenser in accordance with some embodiments of the present disclosure;

FIG. 7 shows a left-side view of an example cabinet of a condiment dispenser in accordance with some embodiments of the present disclosure;

FIG. 8 shows a back view of an example cabinet of a condiment dispenser in accordance with some embodiments of the present disclosure;

FIG. 9A shows a top view of an example cabinet of a condiment dispenser in accordance with some embodiments of the present disclosure;

FIG. 9B shows a bottom view of an example cabinet of a condiment dispenser in accordance with some embodiments of the present disclosure;

FIG. 10 shows a perspective view of an example conveyor in accordance with some embodiments of the present disclosure;

FIG. 11 shows a side view of an example conveyor in accordance with some embodiments of the present disclosure;

FIG. 12 shows a top view of an example conveyor in accordance with some embodiments of the present disclosure;

FIG. 13 shows a perspective view of an example robotic arm and end effector in accordance with some embodiments of the present disclosure;

FIG. 14 shows a perspective view of a portion of an example cabinet of a condiment dispenser in accordance with some embodiments of the present disclosure;

FIG. 15 shows a perspective view of an example robotic arm in accordance with some embodiments of the present disclosure;

FIG. 16 shows a perspective view of an example robotic arm in accordance with some embodiments of the present disclosure;

FIG. 17 shows a perspective view of a portion of an example condiment dispenser in accordance with some embodiments of the present disclosure;

FIG. 18 shows a cross-section of an example end effector in accordance with some embodiments of the present disclosure; and

FIG. 19 shows an example input device including a graphical user interface (GUI) for controlling a condiment dispenser in accordance with some embodiments of the present disclosure.

### DETAILED DESCRIPTION

Some embodiments of the present invention will now be described more fully hereinafter with reference to the accompanying drawings, in which some, but not all, embodiments of the invention are shown. Like reference numerals refer to like elements throughout. Indeed, various embodiments of the invention may be embodied in many different forms and should not be construed as limited to the embodiments set forth herein. Rather, these embodiments are provided so that this disclosure will satisfy applicable legal requirements.

As used herein, the term “or” is used in both the alternative and conjunctive sense, unless otherwise indicated. The term “along,” and similarly utilized terms, means near or on, but not necessarily requiring directly on an edge or other referenced location. The terms “approximately,” “generally,” and “substantially” refer to within manufacturing and/or engineering design tolerances for the corresponding materials and/or elements unless otherwise indicated. Thus, use of any such aforementioned terms, or similarly interchangeable terms, should not be taken to limit the spirit and scope of embodiments of the present invention.

As used herein, reference is made to an automated condiment dispenser for use in conjunction with condiment containers. The present disclosure, however, contemplates that the condiment dispenser of the present disclosure may be equally applicable to other applications in which automatic dispensing of various quantities and types of containers is advantageous. Similarly, reference herein may be made to food service environments, such as restaurant kitchens, in which at least some of the various embodiments may be implemented. However, the present disclosure contemplates that the condiment dispenser described herein may be used in any environment based upon the intended application of the dispensing apparatus. For example, the condiment dispenser may be used in a cafeteria setting. As another example, the condiment dispenser may be configured to dispense other items in addition or as an alternative to condiment containers, such as utensils, cleaning supplies, cooking ingredients, and/or the like.

### Overview

In general, various embodiments of the present disclosure provide improved apparatuses for dispensing condiment containers. For example, the condiment dispenser described herein may be used to automatically dispense varying quantities of condiment containers containing the same or different type of dipping sauce. It will be understood and appreciated that such context is provided by way of example and uses of the apparatus in additional contexts, such as with other food products, are contemplated and within the scope of the invention. For example, the condiment dispenser may be utilized to dispense containers comprising substances or articles other than condiments. In some embodiments, such containers may demonstrate similar form factor to those containing condiments shown in the figures.

As described above, QSRs often face challenges in quickly and accurately fulfilling condiment requests from customer orders. For example, a QSR may offer several types of dipping sauces and, as a result, receive widely varying requests for combinations of sauces. Traditionally, staff members are responsible for manually retrieving condiment containers from bins, drawers, hoppers, and/or the like. For example, a staff member may receive a ticket or observe an order screen and seek out the requisite combination of condiment containers from a set of hoppers, relying upon short term memory to do so. Such manual approaches may result in inaccurate or missing condiment containers due to the high volume and high throughput demands of QSR operation. Further, these existing approaches may reduce efficiency of the QSR due to time spent reviewing condiment requests, searching for the requested condiment containers, and placing combinations of condiment containers into a receptacle.

To solve these issues and others, example implementations of embodiments of the present application may provide an automated condiment dispensing apparatus (“condiment dispenser”) that allows for automated processing and fulfillment of condiment requests. In this manner, the condiment dispenser described hereafter improves efficiency of QSR operation and the accuracy of condiment request fulfillment. Therefore, the condiment dispenser may enable team members to instead perform additional tasks (e.g., processing additional orders, cleaning surfaces, serving customers, etc.) during the same period of time otherwise required for manually fulfilling condiment requests. In doing so, the condiment dispenser may enable further enhancements to restaurant throughput, kitchen safety, and customer satisfaction.

### Example Condiment Dispenser

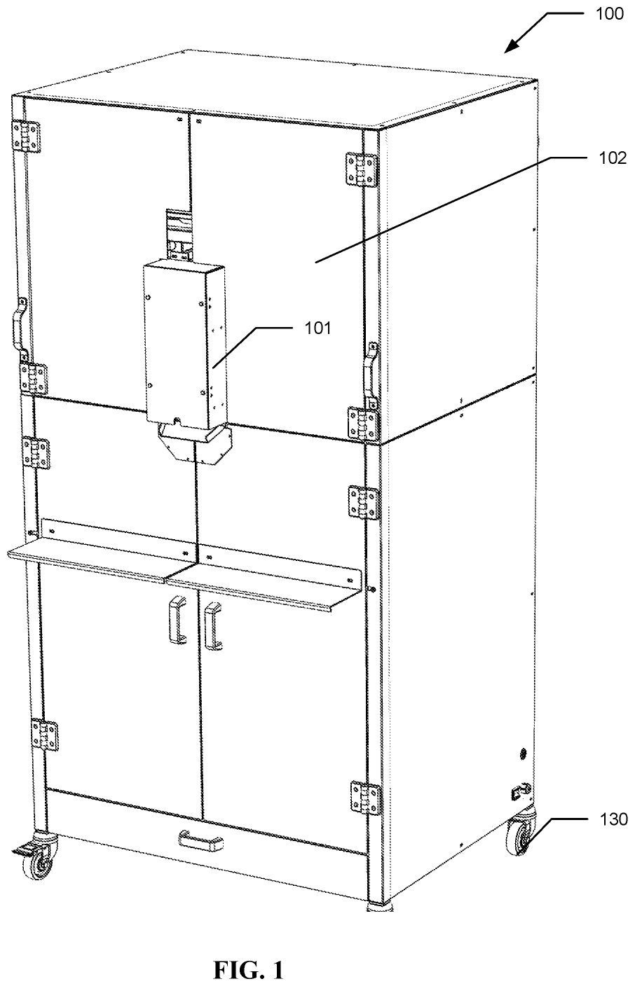

With reference to FIG. 1, an example condiment dispenser 100 for automatically dispensing condiment containers is illustrated. In some embodiments, the condiment dispenser 100 includes one or more dispenser chutes 101 through which condiment containers may be dispensed. For example, the condiment dispenser 100 may dispense a plurality of condiment containers of varying type through the dispenser chute 101. In some embodiments, a receptacle may be oriented beneath the dispenser chute 101 to receive one or more condiment containers. The receptacle may include a to-go bag, food tray, staging counter, operator's hands, and/or the like. In some embodiments, the condiment dispenser 100 includes multiple dispenser chutes 101 that may be used to fulfill multiple different condiment requests simultaneously or asynchronously. For example, the condiment dispenser 100 may include dual dispenser chutes configured to receive condiment containers from different sets of staging surfaces.

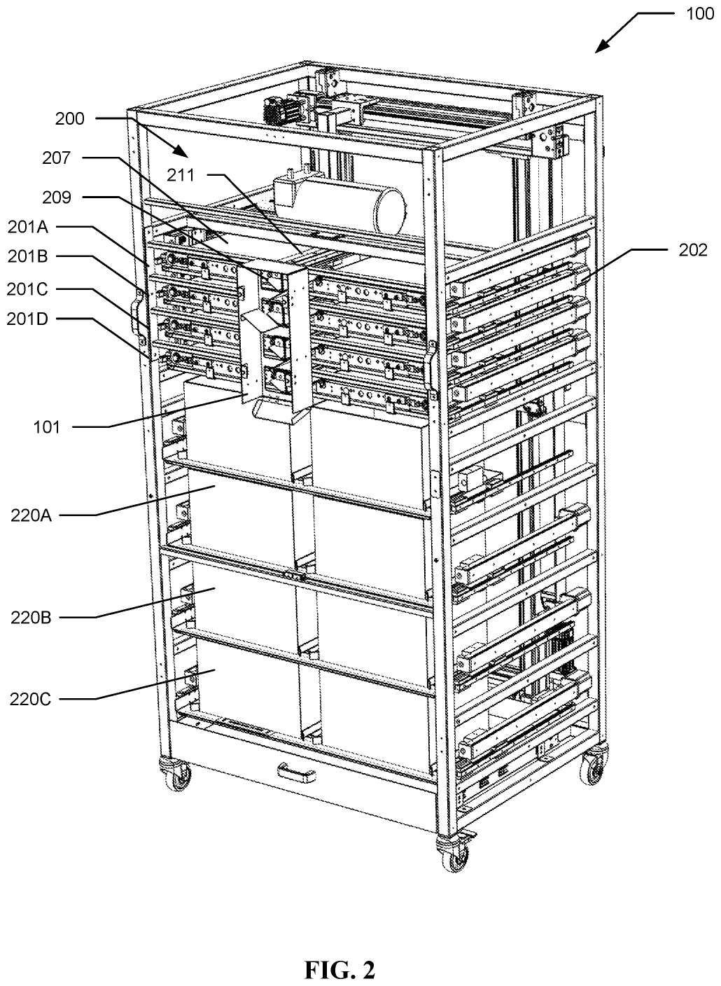

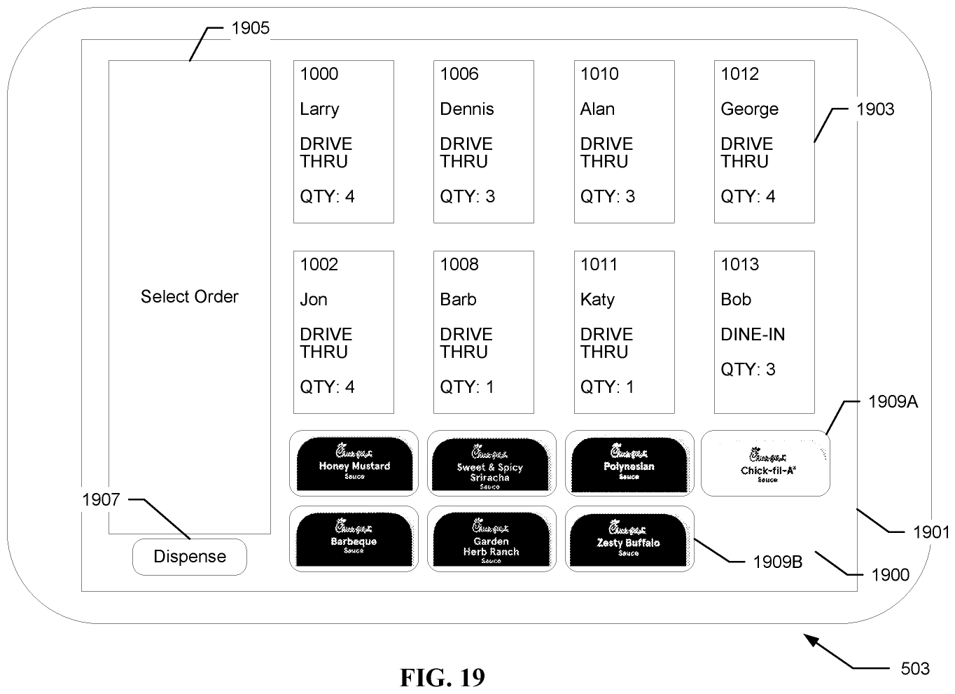

In some embodiments, the condiment dispenser 100 includes an internal cabinet (not shown, see FIGS. 2-8 and 9A-B). In some embodiments the condiment dispenser 100 includes a plurality of doors 102 that provide access to the internal cabinet. The doors 102 may be closed during operation to provide a barrier between operators and moving elements of the condiment dispenser 100. In some embodiments, one or more of the doors 102 include one or more input devices for providing input to a controller of the condiment dispenser 100. A door 102 may include one or more touchscreen displays, buttons, switches, dials, and/or the like by which an operator may request dispensing of condiment containers. As one example, the door 102 may include a touchscreen display including a graphical user interface (GUI) 1901 as shown in FIG. 19 and described herein. In an example sequence of operation, the condiment dispenser 100 may receive a request via an input device or a kitchen production system (KPS), the request defining a quantity of a first condiment type (e.g., two barbecue sauces) and a second quantity of a second condiment type (e.g., one ranch dipping sauce). In response to the request, the condiment dispenser 100 may automatically dispense two containers of barbecue sauce and one container of ranch dipping sauce through the dispenser chute 101. In some embodiments, the dispenser chute 101 includes a sensor configured to detect whether a receptacle is below the dispenser chute. In some embodiments, a controller of the condiment dispenser 100 may delay dispensing condiment containers until the sensor generates a reading indicative of a receptacle beneath the dispenser chute 101.

In some embodiments, the condiment dispenser 100 includes a plurality of casters 130 that render the condiment dispenser mobile. For example, the condiment dispenser 100 may be moved throughout a QSR environment via the casters 130. As another example, the condiment dispenser 100 may be deployed onsite at a customer location, such as an event venue. In some embodiments, the condiment dispenser 100 includes a power unit such that the condiment dispenser 100 may be operated independent of connection to an external power source. For example, the condiment dispenser 100 may include one or more internal batteries, generators, and/or the like that supply power to the controllers, conveyors, actuators, robotic arms, and/or the like described herein.

FIG. 2 shows a front perspective view of an example cabinet 200 of a condiment dispenser 100. The front perspective view illustrates in FIG. 2 omits the doors 102 and other outer surfaces of the condiment dispenser 100 to facilitate observation and description of internal elements.

In some embodiments, the cabinet 200 includes a plurality of shelves. For example, the cabinet 200 may include shelves 201A, 201B, 201C, 201D. The shelves may be vertically oriented as illustrated in FIG. 2. In some embodiments, the vertical arrangement of the shelves improves the compactness of the condiment dispenser 100, which is desirable in many QSR kitchen and preparation environments. In some embodiments, a shelf is attached to a linear actuator 202 such that the shelf may be horizontally translated and reverse translated via the linear actuator 202. For example, the linear actuator 202 may be activated to horizontally translate the shelf in a first direction such that a top surface of the shelf is exposed for depositing of condiment containers. Alternatively, in some embodiments, a shelf is attached to one or more gear and stepper motor systems configured to horizontally translate the shelf along a track.

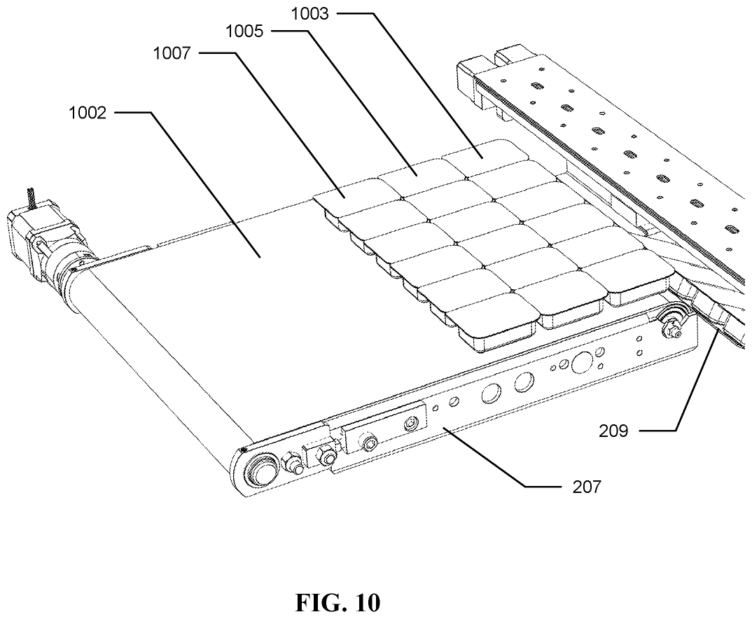

In some embodiments, the shelf includes one or more conveyors 207. In some embodiments, the conveyor 207 is configured to receive one or more condiment containers along a top surface of the conveyor. For example, a conveyor 207 may receive one or more rows of condiment containers as shown in FIGS. 10-12. In some embodiments, the conveyor is configured to, upon activation, advance one or more condiment containers onto a staging surface 209. In some embodiments, the cabinet 200 includes a plurality of staging surfaces 209 that are vertically arranged such that a respective staging surface is in alignment with one of a plurality of vertically arranged shelves. In some embodiments, for a respective shelf, the cabinet 200 includes a pair of staging surfaces 209 that are each configured to receive condiment containers from one of a pair of conveyors of the shelf. In some embodiments, a shelf includes a first conveyor and a second conveyor, each conveyor being configured to advance condiment containers onto a respective staging surface.

In some embodiments, the staging surface 209 extends longitudinally along a width of the conveyor 207 such that the staging surface is sized to receive a row of condiment containers advanced from the conveyor. In some embodiments, an edge of the staging surface 209 is in alignment with a dispenser chute 101 such that a condiment container may be advanced over the edge of the staging surface 209 into the dispenser chute 101. In some embodiments, the staging surface 209 is inclined such that condiment containers advanced onto the staging surface are angled downward.

In some embodiments, the cabinet 200 includes one or more actuators 211 configured to, upon activation, advance along a respective staging surface 209. In various embodiments, the advancement of the actuator 211 is such that, when a row of condiment containers is disposed on the staging surface 209, a subset of the row of condiment containers may be advanced from the staging surface into the dispenser chute 101. For example, a conveyor 207 may be activated by a controller to advance a row of condiment containers onto the staging surface 209. In response to a request for one or more condiments, the actuator 211 may be activated to longitudinally advance a subset of the row of condiment containers from the staging surface 209 into the dispenser chute 101 such that those condiment containers are delivered under gravity into a receptacle.

In some embodiments, a shelf is configured to receive a reservoir comprising condiment containers. For example, a plurality of shelves may receive reservoirs 220A, 220B, 220C, and a respective reservoir may comprise condiment containers of a particular condiment type. The reservoir 220A may include condiment containers comprising barbeque sauce, the reservoir 220B may include condiment containers comprising honey mustard, and the reservoir 220C may include condiment containers comprising Polynesian sauce. The reservoirs may comprise shipping boxes full of condiments received from a condiment supplier. In some embodiments, via the linear actuator 202, the shelf may horizontally forward and reverse translate to expose the reservoir to enable retrieval of one or more condiment containers from the reservoir.

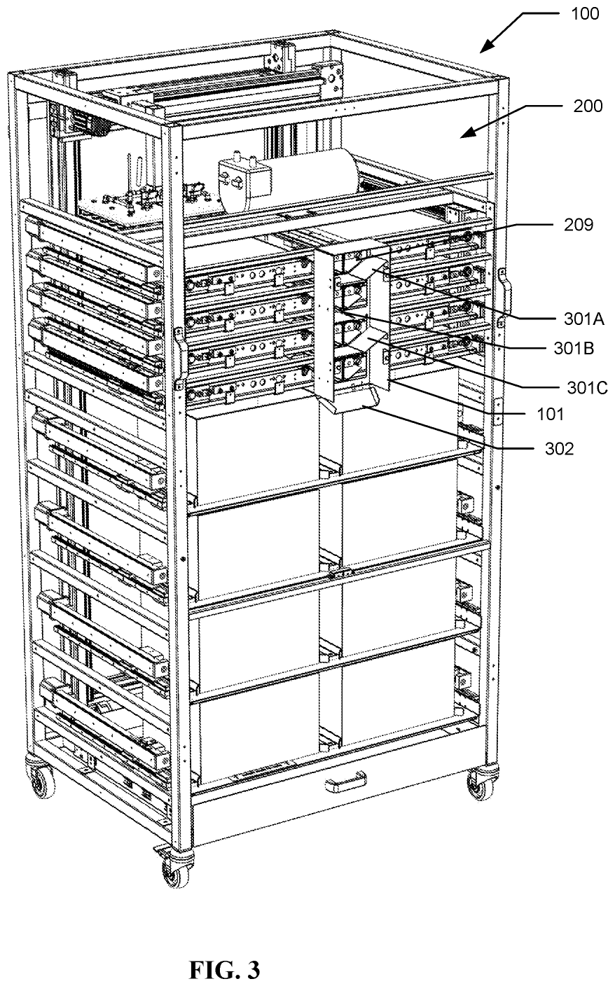

FIG. 3 shows a front perspective view of an example cabinet 200 of a condiment dispenser 100. In some embodiments, the dispenser chute 101 includes a plurality of inclined surfaces 301A, 301B, 301C configured to contact and reduce the acceleration of condiment containers falling through the dispenser chute 101. For example, a condiment container may be longitudinally advanced from the staging surface 209 into the dispenser chute 101. Instead of falling under gravity for the entire height of the dispenser chute 101, the condiment container may fall and/or slide onto the inclined surfaces 301A, 301B, 301C such that the condiment container is dispensed from the condiment dispenser 100 at a reduced acceleration compared to freefall. In some embodiments, the reduction in acceleration is advantageous for reducing a likelihood of the condiment container becoming breached during dispensing or falling with sufficient acceleration to puncture or dislodge a receptacle, such as a paper bag.

In some embodiments, the dispenser chute 101 includes a bottom surface 302 configured to deflect condiment containers at the end their fall through the dispenser chute. In some embodiments, the bottom surface 302 is angled downward and forward extending longitudinally away from the condiment dispenser 100 such that the bottom surface deflects condiment containers away from the condiment dispenser. For example, the bottom surface 302 may deflect condiment containers away from the condiment dispenser 100 into a receptacle positioned proximate to the bottom surface 302. In some embodiments, the bottom surface 302 reduces acceleration of the condiment dispenser prior to its deposition into a receptacle. In doing so, the bottom surface 302 may reduce a likelihood of the condiment container piercing the receptacle and/or dislodging the receptacle from the hands of a team member.

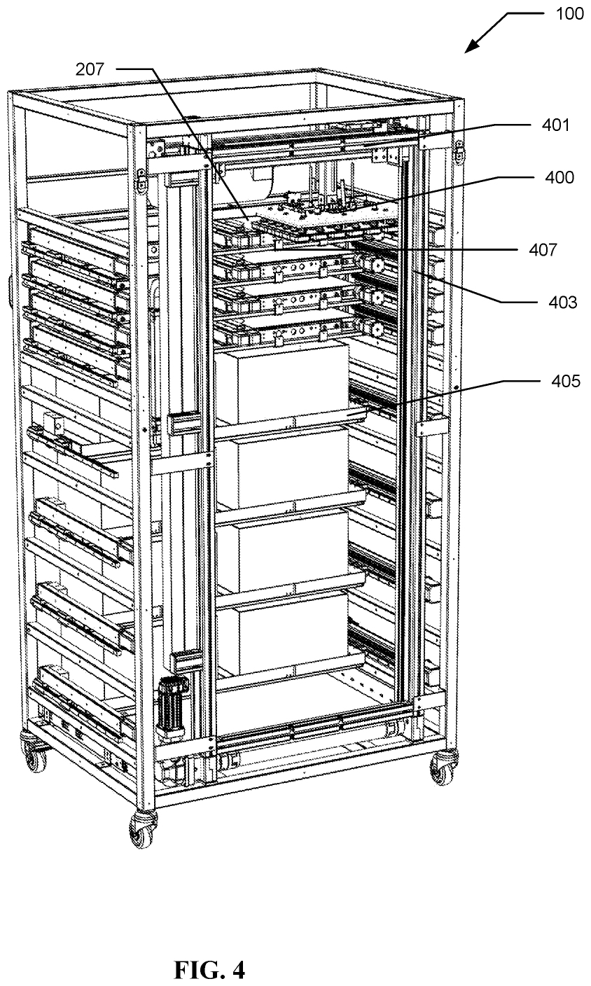

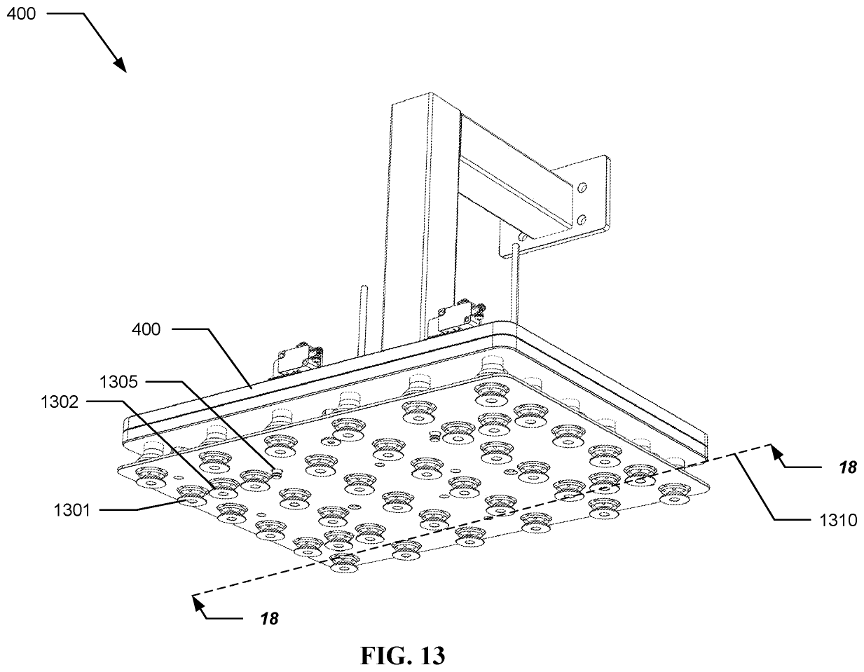

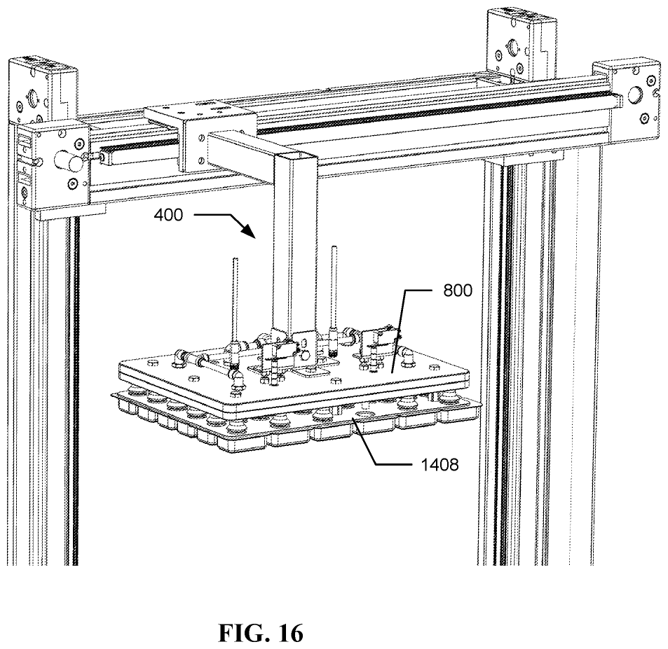

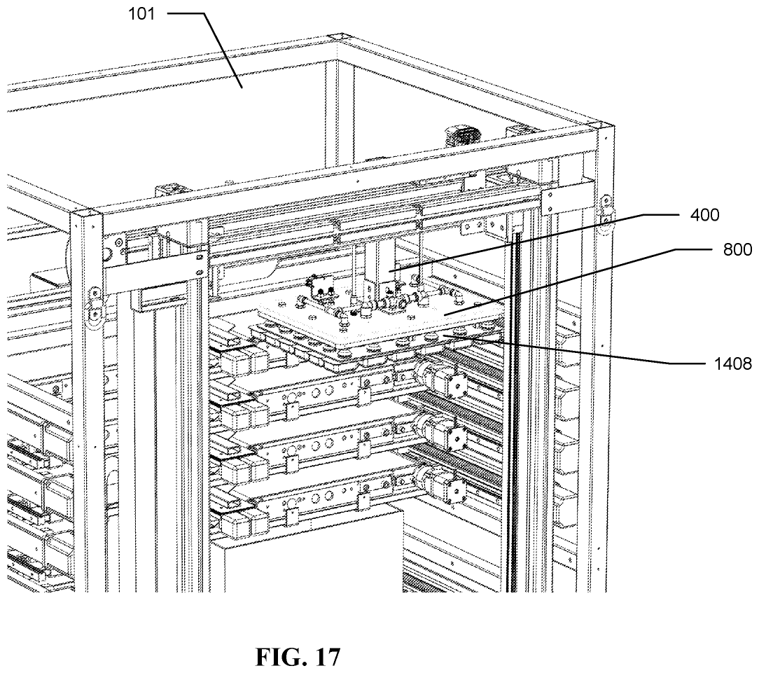

FIG. 4 shows a rear perspective view of an example cabinet 200 of a condiment dispenser 100. In some embodiments, the condiment dispenser 100 includes one or more robotic arms 400 configured to deposit condiment containers onto a conveyor 207. For example, the robotic arm 400 may horizontally and/or vertically translate to align over a conveyor 207 such that a plurality of condiment containers may be released from the robotic arm onto the top surface of the conveyor 207. In some embodiments, as further shown in FIGS. 13-17, the robotic arm 400 includes a plurality of vacuum cups individually configured to secure to a respective condiment container. In some embodiments, the robotic arm 400 is configured to horizontally and/or vertically translate to align the plurality of vacuum cups over one or more rows of condiment containers stored in a reservoir. In some embodiments, the plurality of vacuum cups may be transitioned to an active state such to secure to one or rows of condiment containers via suction. In some embodiments, the robotic arm 400 is configured to reposition to align the one or more suctioned rows of condiment containers over a conveyor 207. Once aligned, the plurality of vacuum cups may be transitioned to an inactive state to release the suction and deposit the one or more rows of condiment containers onto the top surface of the conveyor 207.

In some embodiments, the cabinet 200 includes a horizontal track 401 and one or more vertical tracks 403 configured to facilitate horizontal and vertical repositioning of the robotic arm 400, respectively. For example, the robotic arm 400 may include one or more gear and motor mechanisms configured to translate the robotic arm along the horizontal track 401 or vertical track 403. Alternatively, the robotic arm 400 may include one or more hydraulic actuators configured to articulate the robotic arm 400 between reservoirs and conveyors.

In some embodiments, an example method of depositing condiment containers onto a conveyor 207 includes causing horizontal translation of a first shelf 405 in a first direction to expose a reservoir to the robotic arm 400. For example, a controller may activate a linear actuator or other movement mechanism to horizontally translate the first shelf 405. In some embodiments, the method includes positioning the robotic arm 400 over the reservoir such that the plurality of vacuum cups are aligned over one or more rows of condiment containers stored in the reservoir. For example, a controller may active a gear and motor or other movement mechanism to horizontally and/or vertically reposition the robotic arm over the reservoir. In some embodiments, the method includes securing the plurality of vacuum cups to one or more rows of condiment containers in the reservoir via suction. For example, a controller may activate one or more negative pressure pumps to generate suction at each vacuum cup such that the vacuum cup engages with a flat top surface of a condiment container. In some embodiments, the method includes raising the robotic arm 400 to lift the suctioned condiment containers from the reservoir and/or first shelf 405. In some embodiments, the method includes reverse translating the first shelf 405 to its original position such that the reservoir is no longer exposed to the robotic arm 400.

In some embodiments, the method includes raising the robotic arm 400 such that the vertical position of the suctioned condiment containers is superior to the vertical position of the conveyor 207 onto which the condiment containers will be deposited. In some embodiments, the method includes translating a second shelf 407 that comprises the conveyor 207 such that a top surface of the conveyor is exposed to the robotic arm 400. For example, a controller may activate a second linear actuator to reverse translate the second shelf 407. In some embodiments, the method includes lowering the robotic arm 400 such that the suctioned condiment containers are in contact or near contact with the top surface of the conveyor 207. In some embodiments, the method includes releasing the suction at the plurality of vacuum cups such that the one or more rows of condiment containers are deposited onto the conveyor 207. For example, the controller may deactivate the negative pressure pump and/or engage a release valve to relieve the negative pressurization at the vacuum cups. Additionally, in some embodiments, the method includes applying a positive pressure at the vacuum cups to quickly release suction via elimination of the negative pressurization. For example, the controller may activate one or more compressors to pump air into the vacuum cups to release the suction. In some embodiments, the method includes reverse translating the second shelf 407 to its original position such that the conveyor 207 is realigned with a staging surface.

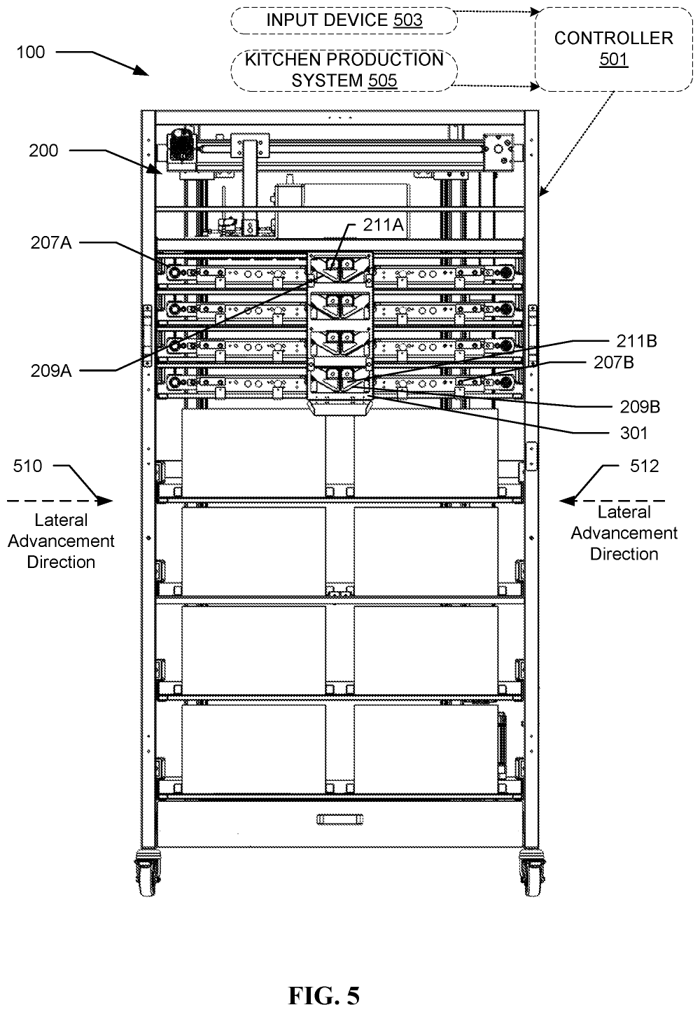

FIG. 5 shows a front view of an example cabinet 200 of a condiment dispenser 100. In some embodiments the condiment dispenser 100 includes a controller 501 configured to control condiment dispensing operations. For example, the controller 501 may control the conveyors, actuators, robotic arms, input devices and/or the like described herein and shown in the figures. In some embodiments, the controller 501 includes one or more input devices 503 configured to receive user input from a team member. For example, the controller 501 may receive a request to dispense condiments based on user input provided to the input device 503. In some embodiments, the input device 503 includes one or more touchscreen displays, buttons, switches, cursor controls, and/or the like. In some embodiments, the controller 501 causes rendering of a GUI on the input device to enable a team member to initiate automated condiment dispensing. In some embodiments, the controller 501 is in communication with a kitchen production system (KPS) 505. In some embodiments, the controller 501 receives customer orders, requests for condiments, and/or the like from the KPS 505. In some embodiments, the controller 501 causes rendering of customer orders on a display of the input device 503. For example, as shown in FIG. 19, the controller 501 may cause rendering of a GUI including customer order and other condiment-related information, such as condiments available to be dispensed.

In some embodiments, a request or customer order defines one or more condiment types and respective quantities of the condiment types that are requested for dispensing. For example, a request may include or indicate three house sauces, two barbecue sauces, and one ranch sauce. As another example, a customer order may include four house sauces and two buffalo sauces. The proceeding description of FIG. 5 is presented in the context of fulfilling the later example by automatically dispensing four house sauces and two buffalo sauces via the condiment dispenser 100.

In some embodiments, an example method of automatically dispensing condiment containers includes advancing respective rows of condiment containers onto a plurality of staging surfaces. For example, a first conveyor 207A may include one or more rows of condiment containers comprising house sauce and a second conveyor 207B may include one or more rows of condiment containers comprising buffalo sauce. The controller 501 may activate the first conveyor 207A to advance a row of house sauce condiment containers in a lateral direction 510 onto a staging surface 209A. Simultaneously or asynchronously, the controller 501 may activate the second conveyor 207B to advance a row of buffalo sauce condiment containers in a second lateral direction 512 onto a staging surface 209B. In some embodiments, the method includes determining that one or more conveyors are empty of condiment containers. For example, the controller 501 may determine that the conveyor 207A is empty following the advancement of the row of house sauce condiment containers onto the staging surface 209A. In some embodiments, in response to the determination, the method includes depositing one or more rows of condiment containers onto the conveyor, which may be performed as described in the foregoing example method provided with reference to FIG. 4.

In some embodiments, the method includes receiving a request to dispense condiments. For example, the controller 501 may receive a request via user input provided to an input device 503, such as a selection for quantities of one or more condiment types or a selection of a customer order. As another example, the controller 501 may receive a customer order from a KPS 505. In some embodiments, the method includes determining a quantity of each type of condiment container to dispense based on the request. For example, a customer order may include four house sauces and two buffalo sauces. The controller 501 may determine that fulfillment of the request includes dispensing four house sauce condiment containers and two buffalo sauced condiment containers.

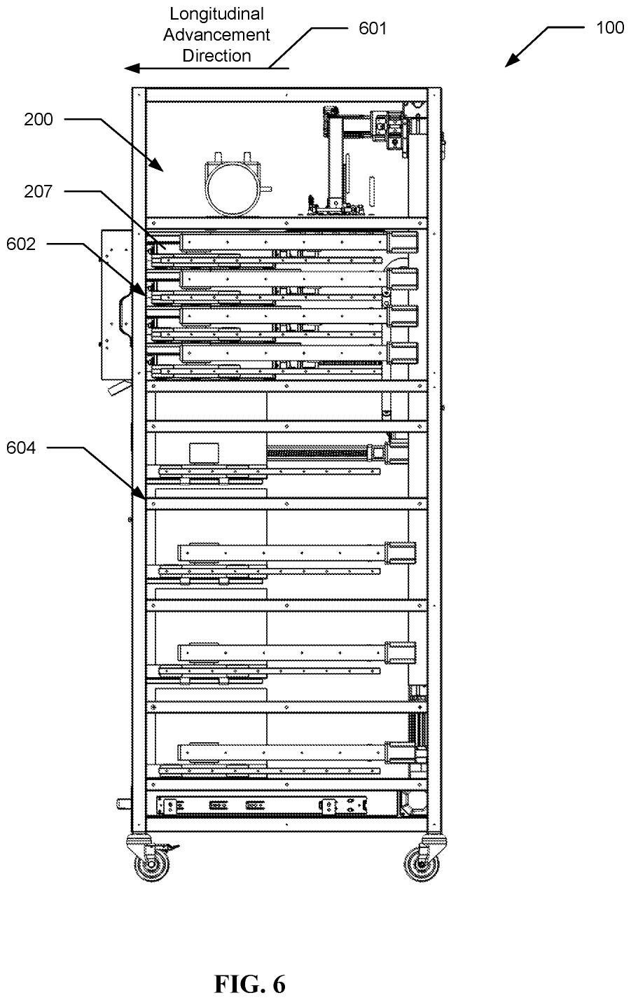

In some embodiments, the method includes longitudinally advancing a subset of a row of condiment containers on one or more staging surfaces into a dispenser chute. For example, the controller 501 may activate an actuator 211A to advance four house sauce condiment containers in a longitudinal direction 601 (FIG. 6) off the staging surface 209A such that the condiment containers drop into the dispenser chute 101 and out of the condiment dispenser 100. Simultaneously or asynchronously, the controller 501 may activate an actuator 211B to advance two buffalo sauce condiment containers in the longitudinal direction 601 off the staging surface 209B such that the containers drop into the same or a different dispenser chute and out of the condiment dispenser 100.

In some embodiments, the method includes determining that a staging surface is empty of condiment containers. For example, the controller 501 may determine whether an actuator extended to a threshold position when advancing condiment containers from the staging surface. As another example, the controller 501 may store in memory a count of the condiment containers on a staging surface prior to fulfillment of a request. The controller 501 may generate an updated count based on subtracting the dispensed quantity of condiment containers, where a result of zero indicates the staging surface is empty of condiment containers. In some embodiments, in response to a determination that the staging surface is empty, the method includes laterally advancing an additional row of condiment containers onto the staging surface. For example, in response to determining the staging surface 209A is empty following fulfillment of a request, the controller 501 may cause the conveyor 207A to advance an additional row of house sauce condiment containers (or other condiment type) onto the staging surface 209A. In some embodiments, in response to a determination that the conveyor is empty of condiment containers, the method includes depositing one or more rows of condiment containers onto the conveyor. In some embodiments, the depositing of one or more rows of condiment containers onto the conveyor may be performed as described in the foregoing example method provided with reference to FIG. 4.

In some embodiments, a customer order may indicate one or more allergies or other restrictions associated with a customer. In some embodiments, the controller 501 may compare the allergy or restriction against condiment information stored in memory, such as ingredients or associations of condiments with one or more allergen or other restriction categories. In some embodiments, the controller 501 may disallow the condiment dispenser 100 from fulfilling a portion of a request to dispense condiments based on the order. For example, a customer order may include one house sauce, one honey mustard, and one buffalo sauce, and the customer order may indicate an egg allergy and a dairy allergy. The controller 501 may compare the requested sauces and allergies to condiment information in memory and determine that the house sauce contains egg and the buffalo sauce contains both egg and dairy. In response to the determination, the controller 501 may determine that only the request for honey mustard may be fulfilled when commanding the condiment dispenser 100 to dispense the requested condiments. In some embodiments, in response to determining a request for condiments would violate one or more indicated allergens or other restrictions, the controller 501 causes rendering of an alert on the input device 503 to flag instances where condiment containers may not be dispensed (or where such dispensing is not recommended) respective to a customer order.

FIG. 6 shows a right-side view of an example cabinet 200 of a condiment dispenser 100. In some embodiments, a set of shelves 602 for holding conveyors 207 is vertically arranged above or beneath a set of shelves 604 for holding reserves of condiment containers. Further, respective staging surfaces and actuators for dispensing condiment containers out of the condiment dispenser 100 may be aligned with individual ones of the set of shelves 602. In some embodiments, the vertical arrangement of elements for dispensing and storing condiment containers advantageously reduces a spatial footprint required to store and fulfill condiment requests. For example, in existing QSR environments, boxes of condiment containers typically take up substantial space on countertops proximate to the drive thru window and dine-in checkout areas. By consolidating condiment storage and dispensing into a single unit, the condiment dispenser 100 may increase available space in these and other areas of the QSR environment.

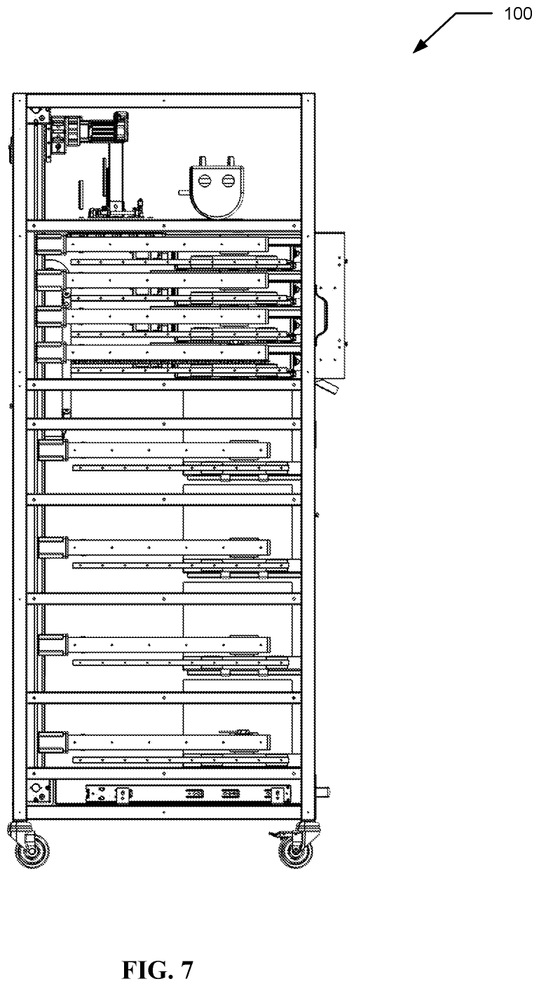

FIG. 7 shows a left-side view of an example cabinet 200 of a condiment dispenser 100.

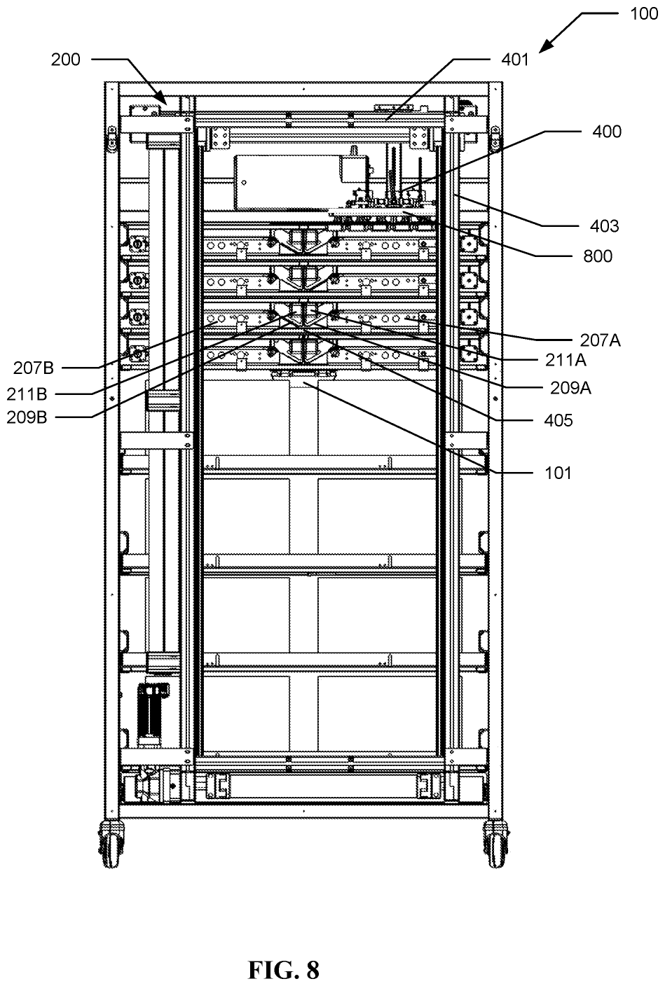

FIG. 8 shows a back view of an example cabinet 200 of a condiment dispenser 100. As described in the preceding sections, the cabinet 200 may include a robotic arm 400 configured to translate along one or more horizontal tracks 401 and vertical tracks 403. In some embodiments, the robotic arm 400 includes an end effector 800 that includes a plurality of vacuum cups for securing to condiment containers via suction. In some embodiments, the end effector 800 is connected to one or more pumps configured to generate suction at the vacuum cups by applying negative pressurization. In some embodiments, the end effector 800 is connected to one or more pumps configured to quickly release suction at the vacuum pumps by providing positive pressurization.

In various embodiments, a shelf 405 includes a pair of conveyors 207A, 207B that may be independently loaded with one or more rows of condiment containers and controlled to laterally translate the condiment containers. In some embodiments, the shelf 405 is aligned with a pair of staging surfaces 209A, 209B that may be independently loaded with a row of condiment containers. In some embodiments, a staging surface is aligned with an actuator that may be controlled to longitudinally translate a row of condiment containers (or subset thereof) along a staging surface. For example, the pair of staging surfaces 209A, 209B may be aligned with a pair of actuators 211A, 211B, respectively. Each actuator 211A, 211B may be independently controlled to advance condiment containers into the dispenser chute 101 such that the condiment containers fall out of the condiment dispenser 100.

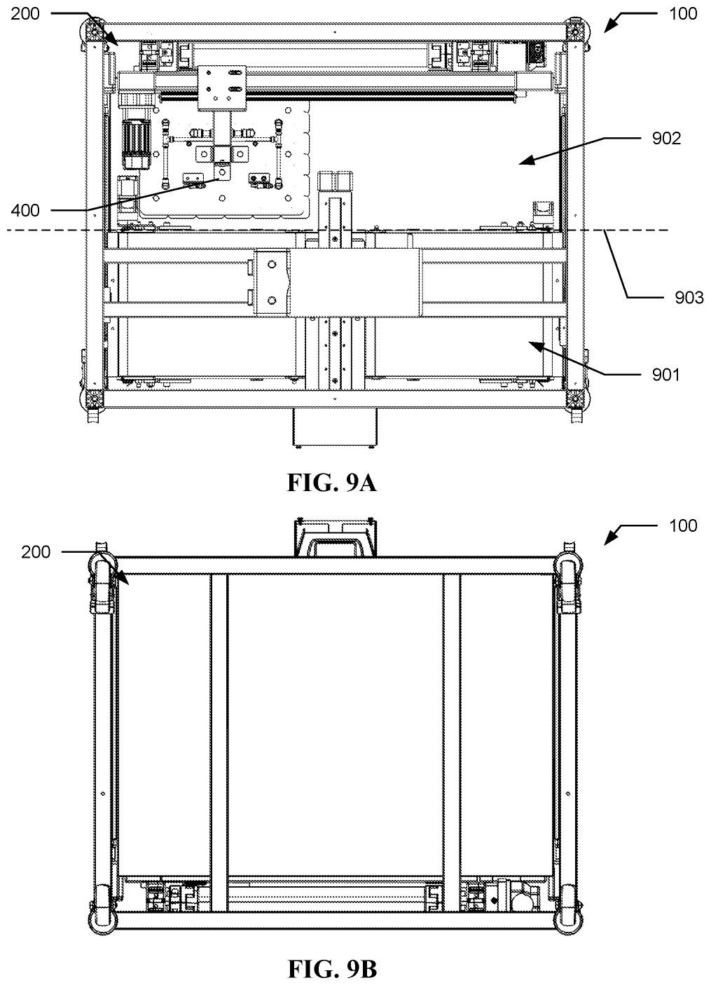

FIG. 9A shows a top view of an example cabinet 200 of a condiment dispenser 100. In some embodiments, the cabinet 200 includes a first zone 901 that houses elements for dispensing condiment containers and a second zone 902 within which one or more elements of the first zone 901 may be loaded with condiment containers. A lateral plane 903 may represent a boundary between the first zone 901 and the second zone 902. In some embodiments, the robotic arm 400 is configured to operate within the second zone 902. In some embodiments, shelves of the condiment dispenser are configured to translate into and out of the second zone 902 from the first zone 901. For example, a shelf including reserves of condiment containers may be translated into the second zone 902 to enable the robotic arm 400 to retrieve one or more rows of condiment containers. A second shelf including a conveyor may translate into the second zone 902 to enable the robotic arm 400 to deposit the one or more rows of condiment containers onto a top surface of the conveyor.

FIG. 9B shows a bottom view of an example cabinet 200 of a condiment dispenser 100.

FIG. 10 shows a perspective view of an example conveyor 207. As described, the conveyor 207 may include a top surface 1002 configured to receive a plurality of rows of condiment containers. For example, the top surface 1002 may receive condiment container rows 1003, 1005, 1007. The top surface 1002 may engage with the flat surface of a respective condiment container. While shown as solid in FIG. 10, the operating surface of the conveyor 207 may embody a grid, mesh, grate, screen, and/or the like. In some embodiments, an edge of the operating surface of the conveyor 207 is aligned against an edge of a staging surface 209 such that a row of condiment containers may be advanced over the edge of the operating surface onto to the staging surface 209. In some embodiments, the conveyor 207 (or other element of the condiment dispenser cabinet) includes a sensor configured to detect deposition of a row of condiment containers onto the staging surface 209. The sensor may include an optical sensor, capacitance sensor, proximity sensor, and/or the like. In some embodiments, the conveyor 207 (or other element of the condiment dispenser cabinet) includes a sensor configured to detect a count of condiment container rows on the top surface 1002 or an absence of condiment container rows on the top surface 1002. In some embodiments, the controller of the condiment dispenser receives and processes sensor reading to determine that additional condiment containers should be deposited onto the conveyor 207.

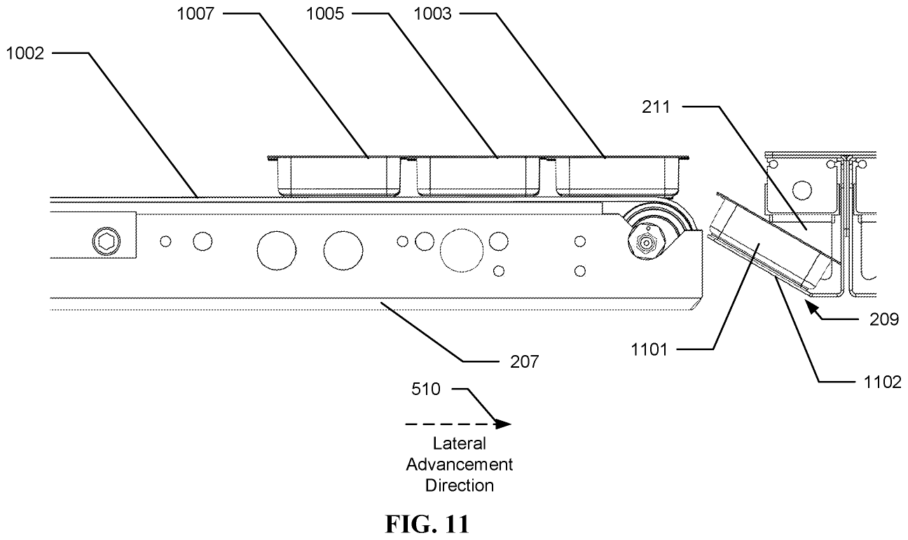

FIG. 11 shows a side view of an example conveyor 207. As described in the preceding sections, the conveyor 207 may be activated to laterally advance a row of condiment containers onto the staging surface 209. The actuator 211 may be activated to longitudinally advance a subset of the row from the staging surface 209 into a dispenser chute. For example, the actuator 211 may be activated to longitudinally advance a single condiment container 1101 over a front edge 1102 of the staging surface 209 and into a dispenser chute. In some embodiments, the actuator 211, staging surface 209, or another other element of the condiment dispenser cabinet includes a sensor configured to detect that the actuator 211 has extended by a full longitudinal length of the staging surface such that a controller may determine that the staging surface is empty, and an additional row of condiment containers may be deposited.

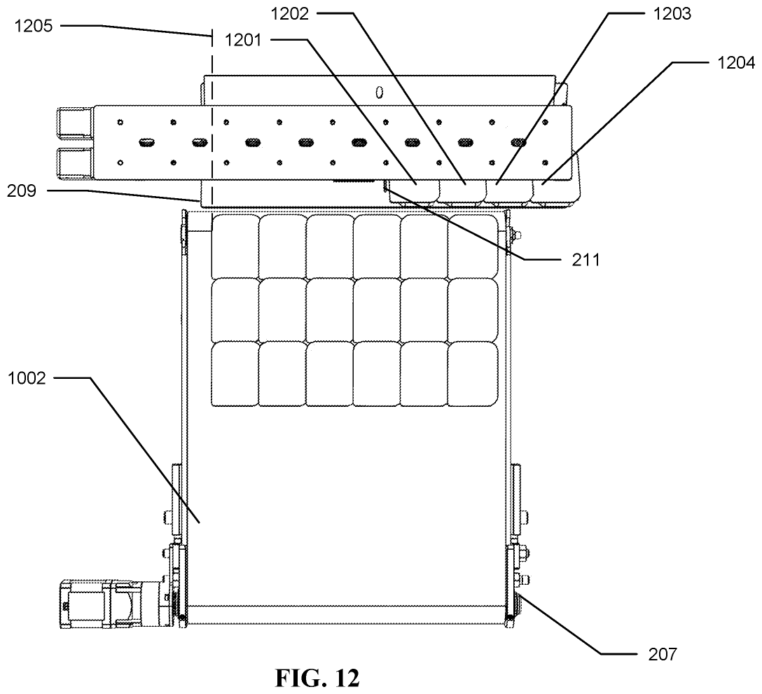

FIG. 12 shows a top view of an example conveyor 207. The top view further illustrates a partial extension of the actuator 211 along the staging surface 209. In some embodiments, in response to determining that the actuator 211 is fully extended or, otherwise, that the staging surface 209 is empty, the controller of the condiment dispenser causes the actuator 211 to fully retract to enable depositing of an additional row of condiment dispensers onto the staging surface 209. For example, in response to determining that the four remaining condiment containers 1201, 1202, 1203, 1204 have been dispensed and/or the actuator 211 is fully extended, the controller may determine that the staging surface 209 is empty. Prior to advancing an additional row of condiment containers onto the staging surface 209 via the conveyor 207, the controller may command the actuator 211 return to an initial longitudinal position indicated by lateral plane 1205.

FIG. 13 shows a perspective view of an example robotic arm 400 and end effector 800. In some embodiments, the end effector 800 includes a plurality of vacuum cups 1301. In some embodiments, the arrangement pattern of the plurality of vacuum cups 1301 is configured to match the storage pattern of condiment containers in a reservoir such that each vacuum cup aligns with a respective condiment container. In some embodiments, a vacuum cup 1301 is configured to engage with a flat top surface of a condiment container. In some embodiments, a vacuum cup 1301 is connected to one or more pumps configured to generate suction at the end of the vacuum cup via negative pressurization. The negative pressurization of the vacuum cup may be referred to as an “active state,” and the lack of negative pressurization and/or present of positive pressurization may be referred to as an “inactive state.” As previously described herein, the vacuum cup 1301 may secure to the flat top surface of a condiment container while in the active state and release the condiment container when transitioned to the inactive state. In some embodiments, the vacuum cup 1301 includes multiple stages, where a respective stage is configured to prevent suction of leaked condiment and/or the like into the vacuum cup or connected pressurization system. For example, one or more stages of the vacuum cup may include a filter, screen, mesh, seal, and/or the like that opposes movement of liquid into the vacuum cup.

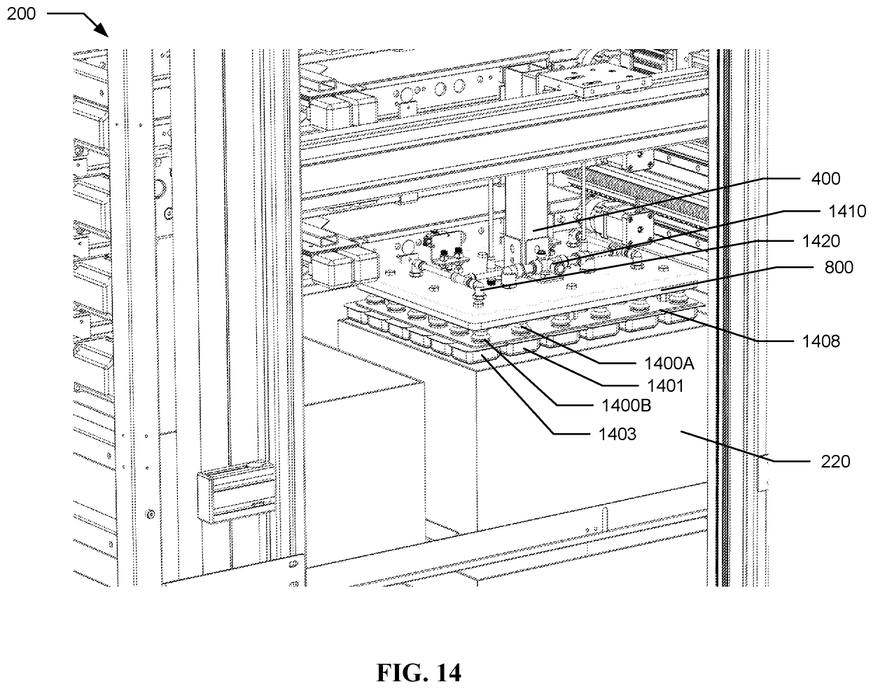

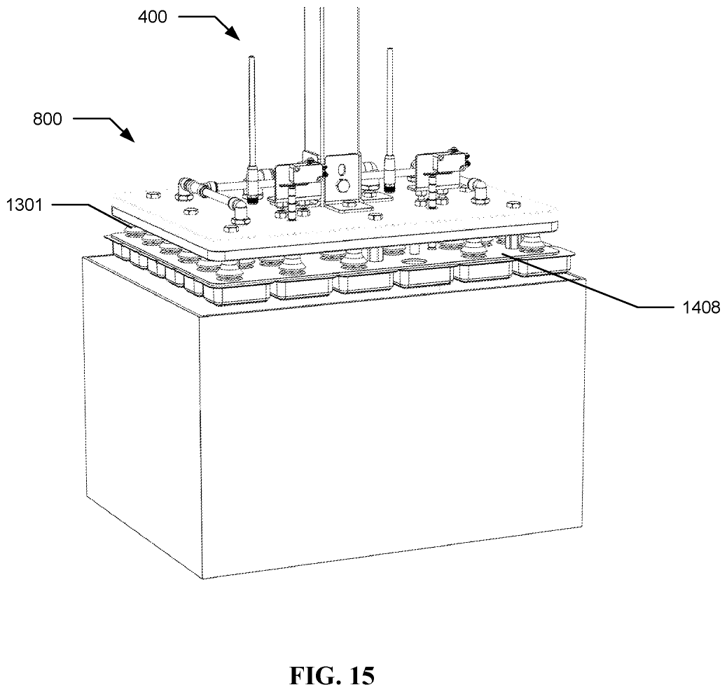

In some embodiments, layers of condiment containers may be separated by a product divider 1400 as shown in FIG. 14. In some embodiments, the robotic arm 400 may secure to and remove the product divider 1400. In some embodiments, the robotic arm 400 is positioned such that one or more vacuum cups 1301 of the end effector 800 are positioned against the product divider 1400. Once positioned, negative pressurization may be applied to the vacuum cup 1301 to suction the product divider 1400 to the end effector. In some embodiments, a product divider 1400 includes voids for enabling a team member to observe the next layer of condiment containers. The voids may undesirably result in suction of both the product divider 1400 and the condiment containers simultaneously. To overcome this challenge, in some embodiments, the end effector 800 includes a set of secondary vacuum cups 1302 that are arranged in a pattern such that none of the secondary cups 1302 aligns with the condiment containers exposed by the product divider voids. In some embodiments, the secondary vacuum cups 1302 are configured such that negative pressurization may be independently applied at the secondary vacuum cups without pressurizing the vacuum cups 1301. As shown in FIGS. 15-17, the robotic arm may transport the product divider 1500 in combination with the condiment containers. In such instances, the robotic arm 400 may remove the product divider 1500 subsequent to depositing the condiment containers onto a conveyor. Alternatively, in some embodiments, the robotic arm 400 removes the product divider 1400 prior to transporting the condiment containers to a conveyor. The removed product divider may be deposited by the robotic arm 400 into a storage receptacle within the cabinet.

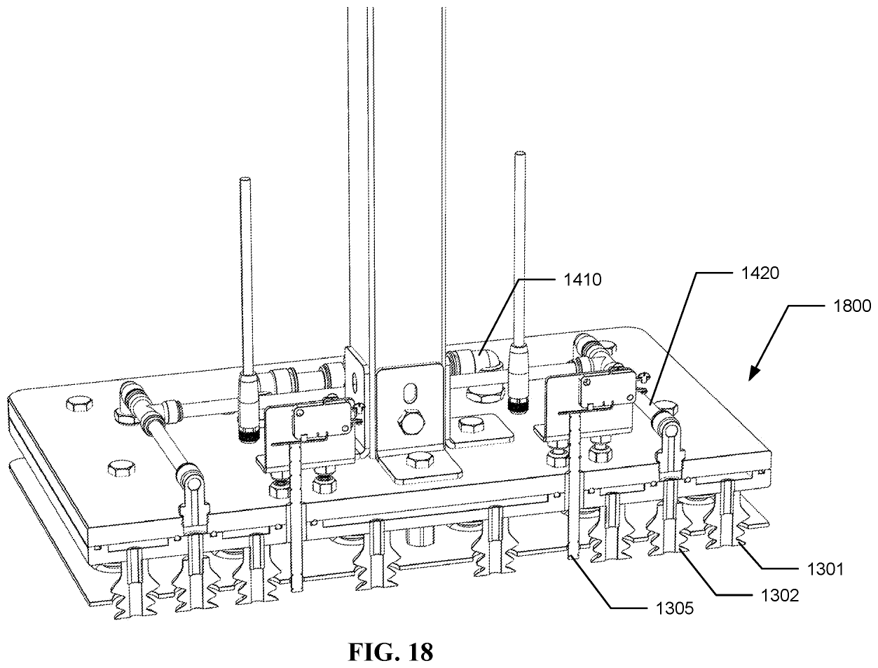

In some embodiments, the end effector 800 includes a plurality of jets 1305 configured to receive and pass positive pressure for supporting release of the suction at one or more vacuum cups. For example, air may be pumped into and through the jet 1305 to contact a suctioned condiment container such that the air pressure relieves the suction and releases the condiment container from the vacuum cup 1301 (e.g., or a product divider from a secondary vacuum cup). In various embodiments, an axis 1310 indicates a cross-section 1800 of the end effector 800 shown in FIG. 18 and described herein.

FIG. 14 shows a perspective view of a portion of an example cabinet 200 of a condiment dispenser. In some embodiments, the end effector 800 includes a first negative pressurization system 1410 coupled to the vacuum cups 1301 and a second negative pressurization system coupled to a plurality of secondary vacuum cups 1302 (see FIG. 13). In some embodiments, the first and second negative pressurization systems are engaged while the robotic arm 400 is positioned such that the vacuum cups are aligned and in contact or near contact with the flat top surfaces of one or more rows of condiment containers and a product divider atop the condiment containers. For example, vacuum cup rows 1400A and 1400B (e.g., and secondary vacuum cups, not shown) may be lowered onto condiment container rows 1401, 1403 and the product divider 1408. The first negative pressurization system 1410 may be engaged to generate suction at the vacuum cups such that the vacuum cup rows 1400A, 1400B secure to condiment containers in the corresponding rows 1401, 1403. The second negative pressurization system 1420 may be engaged to generate suction at the secondary vacuum cups such that the product divider 1408 secures to the end effector 800. The robotic arm 400 may then be repositioned to move and deposit the secured condiment containers and product divider onto a top surface of a conveyor.

In some embodiments, the condiment containers are stored in a reservoir 220. In some embodiments, the robotic arm 400 lowers such that the end effector 800 is lowered into the reservoir 220. In some embodiments, for accurate positioning, the robotic arm 400 includes a sensor (e.g., time of flight sensor, ultrasonic sensor, and/or the like) configured to measure a distance between the bottom surface of the end effector 800 and one or more top-arranged rows of condiment containers in the reservoir 220.

In some embodiments, once the robotic arm 400 and appropriate shelf are repositioned such that the end effector is aligned with a top surface of a conveyor, the first negative pressurization system 1410 is disengaged to remove the negative pressurization at the vacuum cups. The loss of negative pressurization may relieve the suction and cause the condiment containers to release from the vacuum cups onto the conveyor surface. In some embodiments, a positive pressurization system (not shown) is engaged to deliver one or more blasts of air pressure onto the condiment containers such that the suction is more rapidly opposed and released. The second negative pressurization system 1420 may remain engaged such that the product divider 1408 remains attached to the end effector 800.

FIG. 18 shows a cross-section 1800 of an example end effector. As described the vacuum cups 1301 may be coupled to a first negative pressurization system 1410 and the secondary vacuum cups 13032 may be separately coupled to a second negative pressurization system 1420, thereby enabling independent control of suction at the respective vacuum cups. Further, a jet 1305 may include extend through and out of the end effector such that an outlet of the jet 1305 is positioned proximate to condiment containers, product divider, and/or the like, secured to the end effector.

FIG. 19 shows an example input device 503 including a graphical user interface (GUI) 1900 for controlling a condiment dispenser in accordance with some embodiments of the present disclosure. In some embodiments, a controller 501 as shown in FIG. 5 and described herein is connected to or includes the input device 503. In some embodiments, the input device 503 includes a display 1901 on which the GUI 1900 may be rendered. In some embodiments, the GUI 1900 includes a plurality of selectable fields for requesting dispensing of condiment containers from a condiment dispenser (e.g., condiment dispenser 100 as described herein and shown in the accompanying drawings).

In some embodiments, a selectable field is representative of a customer order and includes details associated with the order. For example, a selectable field 109 may be representative of a customer order number 1012 and include a customer name (“George”), an order type (“drive thru” or “dine-in”), and a total quantity of condiments associated with the order (e.g., 4, 3, 1, or other suitable value). In some embodiments, in response to the input device 503 receiving a selection of a selectable field 109, a dispense summary 1905 is rendered in a region of the GUI 1900. For example, customer order 1012 may include two house sauces and two buffalo sauces. In response a selection of the selectable field 1909, a dispense summary 1905 listing the two house sauces and two buffalo sauces may be rendered on the GUI 1900.

In some embodiments, the GUI includes a dispense field 1907 configured to initiate a request to dispense condiment containers. In some embodiments, to dispense condiments for a particular customer order, a team member may select the selectable field associated with the customer order and subsequently select the dispense field 1907 to initiate a request to dispense the condiment containers associated with the customer order. For example, to dispense customer order 1012, a team member may first select the selectable field 1903 then select the dispense field 1907 to cause the condiment dispenser to dispense two house sauces and two buffalo sauces.

In some embodiments, a selectable field is associated with requesting dispensing condiment containers of a particular condiment type (e.g., honey mustard, sweet and spicy sriracha, Polynesian, house sauce, barbeque, garden herb ranch, zesty buffalo, etc.). In some embodiments, the GUI 1900 includes a plurality of condiment type selectable fields such that a team member may request a combination of condiment quantities of varying condiment types by providing selections to the corresponding fields. For example, the GUI 1900 may include a field 1909A for house sauce and a field 1909B for buffalo sauce. To request dispensing of four house sauces and two buffalo sauces, a team member may select the field 1909A four times and the field 1909B twice to allocate the requested condiment container types and quantities and select the dispense field 1907 to provide the request to the controller of the condiment dispenser. In some embodiments, selection of a type-specific field may cause rendering of an adjustable counter or other quantity configuration tool on the GUI 1900. In some embodiments, the GUI 1900 displays a remaining quantity of condiment containers of each condiment type that are stored within the condiment dispenser such that a team member may determine when to restock the condiment dispenser.

### CONCLUSION

While some embodiments described herein relate to automated condiment container dispensing, one of ordinary skill in the art will appreciate that the teachings herein may also apply to a wide range of containers. Some such additional applications may include dispensing containers of cooking ingredient, cleaning supplies, utensils, or food items. The embodiments described herein may also be scalable to accommodate at least the aforementioned applications. Various components of embodiments described herein can be added, removed, reorganized, modified, duplicated, or the like as one skilled in the art would find convenient and/or necessary to implement a particular application in conjunction with the teachings of the present disclosure. In some embodiments, specialized features, characteristics, materials, components, and/or equipment may be applied in conjunction with the teachings of the present disclosure as one skilled in the art would find convenient and/or necessary to implement a particular application.

Moreover, many modifications and other embodiments of the present disclosure set forth herein will come to mind to one skilled in the art to which this disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of any appended claims. Moreover, although the foregoing descriptions and the associated drawings describe example embodiments in the context of certain example combinations of elements and/or functions, it should be appreciated that different combinations of elements and/or functions can be provided by alternative embodiments without departing from the scope of any appended claims. In this regard, for example, different combinations of elements and/or functions than those explicitly described above are also contemplated as can be set forth in some of any appended claims. Although specific terms are employed herein, they are used in a generic and descriptive sense only and not for purposes of limitation.

That which is claimed is:

1. An apparatus for automatically dispensing condiment containers comprising:
a cabinet comprising a plurality of shelves;
a dispenser chute centrally aligned in front of a plurality of staging surfaces, wherein:
the plurality of staging surfaces are vertically arranged; and
an edge of a respective staging surface is adjacent to the dispenser chute;
a respective shelf aligned with a respective staging surface and comprising:
at least one conveyor configured to receive at least one row of condiment containers and, upon activation, advance a respective row of condiment containers onto the staging surface;
at least one actuator configured to, upon activation, advance at least a subset of the respective row of condiment containers from the staging surface into the dispenser chute; and
at least one controller configured to control activation of the at least one conveyor and the at least one actuator.

2. The apparatus of claim 1, wherein:
the at least one controller is further configured to:
activate at least one conveyor to dispense at least one row of condiment containers onto the respective staging surface;
receive a request from at least one of an input device or a kitchen production apparatus (KPS), wherein the request defines at least one condiment type and at least one condiment quantity; and
activate at least one actuator based on the request to enable dispensing of at least one condiment container of the at least one condiment type and at least one condiment quantity.

3. The apparatus of claim 1, further comprising:
a robotic arm comprising a plurality of vacuum cups;
a respective vacuum cup configured to i) in an activated state, attach to a condiment container via suction, and ii) in a deactivated state, release the condiment container via suspension of the suction, wherein the robotic arm is configured to:
align at least a subset of the plurality of vacuum cups over at least one row of condiment containers stored in a reservoir; and
in response to a transition of the subset of the plurality of vacuum cups to the activated state, align the plurality of vacuum cups over the at least one conveyor to enable depositing of the at least one row of condiment containers via a transition of the subset of the plurality of vacuum cups to the deactivated state.

4. The apparatus of claim 3, wherein:
the at least one controller is further configured to:
determine that a quantity of condiment containers on the at least one conveyor is less than a predetermined threshold; and
in response to the determination, activate the robotic arm to enable depositing of the at least one row of condiment containers on the at least one conveyor.

5. The apparatus of claim 4, wherein:
a respective shelf is attached to a linear actuator; and
the at least one controller is further configured to:
in response to the determination that the quantity of condiment containers on the at least one conveyor is less than the predetermined threshold, cause the linear actuator to horizontally translate the shelf such that a top surface of the at least one conveyor is exposed to the robotic arm; and
following the depositing of the at least one row of condiment containers on the at least one conveyor, cause the linear actuator to reverse translate the shelf to realign the at least one conveyor with a respective staging surface.

6. The apparatus of claim 3, wherein:
a respective vacuum cup is configured to engage a flat top surface of the condiment container.

7. The apparatus of claim 6, wherein:
the at least one conveyor is configured to engage a flat bottom surface of the condiment container.

8. The apparatus of claim 7, wherein:
the robotic arm further comprises at least one secondary vacuum cup configured to secure to a product divider disposed on top of the condiment container via suction when configured to an active state.

9. The apparatus of claim 1, further comprising:
an input device configured to receive user input defining a request to dispense at least one quantity of at least one type of condiment from the cabinet;
the at least one controller further configured to:
receive the request from the input device; and
activate at least one of the conveyor and the actuator of at least one the plurality of shelves to enable dispensing of at least one condiment container based on the at least one quantity and the at least one condiment type.

10. The apparatus of claim 9, wherein:
the input device comprises a touchscreen display; and
the at least one controller further configured to:
receive at least one customer order;
generate the at least one quantity and the at least one type of condiment based on the customer order; and
cause rendering of the at least one customer order on the touchscreen display, wherein the user input defining the request comprises a selection of the at least one customer order.

11. An apparatus for automatically dispensing condiment containers, comprising:
at least one staging surface adjacent to a dispenser chute;
the dispenser chute defining a void for dispensing condiment containers under gravity;
at least one conveyor configured to receive a plurality of condiment containers and, upon activation, advance a subset of the plurality of condiment containers onto the at least one staging surface;
at least one actuator configured to, upon activation, advance the respective condiment container from the at least one staging surface into the dispenser chute; and
at least one controller configured to:
obtain a request to dispense at least one condiment container; and
activate the at least one conveyor and the at least one actuator based at least in part on the request.

12. The apparatus of claim 11, wherein:
the at least one conveyor comprises a plurality of conveyors;
a respective conveyor is configured to receive a plurality of condiment containers and, upon activation, advance a subset of the plurality of condiment containers onto a respective staging surface;
the at least one actuator comprises a plurality of actuators, wherein each of the plurality of actuators is aligned with a respective conveyor;
the at least one controller is configured to:
determine at least one condiment type and at least one quantity based at least in part on the request; and
activate at least one conveyor of the plurality of conveyors and/or at least one actuator of the plurality of actuators based at least in part on the at least one condiment type and the at least one quantity to dispense the at least one condiment container from the dispenser chute.

13. The apparatus of claim 12, further comprising:
a display, wherein the at least one controller is further configured to:
render, on the display, a graphical user interface (GUI); and
obtain the request to dispense the at least one condiment container via at least one input to the GUI.

14. The apparatus of claim 13, wherein:
the GUI comprises a plurality of selectable fields associated with a plurality of condiment types, respectively; and
the at least one controller is configured to obtain the request to dispense the at least one condiment container in response to the GUI receiving at least one selection of one of the plurality of selectable fields.

15. The apparatus of claim 14, wherein:
each of a subset of the plurality of selectable fields is associated with a customer order, wherein a respective customer order comprises the at least one condiment type and the at least one quantity.

16. A method for automatically dispensing condiment containers comprising:
laterally advancing a row of condiment containers from a flat surface onto at least one staging surface;
receiving a request for at least one condiment container; and
based on the request, longitudinally advancing at least a subset of at least one row of condiment containers to an end of the staging surface to cause the subset of the at least one row of condiment containers to fall into a dispenser chute.

17. The method of claim 16, wherein:
the at least one staging surface comprises a first staging surface associated with a first condiment type and a second staging surface associated with a second condiment type;
the request defines a quantity of the first condiment type and a second quantity of the second condiment type; and
the method further comprises:
longitudinally advancing a subset of a row of condiment containers of the first staging surface into the dispenser chute; and
longitudinally advancing a second subset of a second row of condiment containers of the second surface into the dispenser chute.

18. The method of claim 16, further comprising:
horizontally translating the flat surface from a first position to a second position;
applying suction to an additional row of condiment containers to enable repositioning;
aligning the additional row of condiment containers over the flat surface;
releasing the suction to deposit the additional row of condiment containers onto the flat surface; and
reverse translating the flat surface from the second position to the first position.

19. The method of claim 16, wherein:
the request is received from a kitchen production apparatus (KPS).

20. The method of claim 16, wherein:
the request comprises a customer order; and
the method further comprises:
determining a quantity of condiment containers in the subset of the row of condiment containers based on the customer order.
